(19) United States
(12) Patent Application Publication
(10) Pub. No.: US 2026/0368866 A1
(43) Pub. Date: Nov. 19, 2026

(54) METHOD, DEVICE, STORAGE MEDIUM AND PROGRAM PRODUCT OF SHADOW ELIMINATION

(71) Applicant: Beijing Zitiao Network Technology Co., Ltd., Beijing (CN)

(72) Inventor: Lixue Gong, Beijing (CN)

(21) Appl. No.: 19/143,875

(22) PCT Filed: May 10, 2024
(86) PCT No.: PCT/CN2024/092488

§ 371 Date: Jun. 26, 2025

(30) Foreign Application Priority Data
May 10, 2023 (CN) 202310525253.X

(51) Int. Cl. G06T 5/77; G06T 3/40; G06T 5/60; G06T 5/70

(52) U.S. Cl. CPC G06T 5/77; G06T 3/40; G06T 5/60; G06T 5/70; G06T 2207/10024; G06T 2207/20021; G06T 2207/20081; G06T 2207/20084; G06T 2207/30168; G06T 2207/30176

(57) ABSTRACT

The embodiments of the disclosure provide a method, a device, a storage medium and a program product for shadow elimination. An initial image to be processed and including a shadow is obtained. Based on the initial image and a shadow prediction model, a shadow image corresponding to the initial image is obtained, where the shadow image is an image presented by a shadow in the initial image, and the shadow image excludes image content of the initial image. Based on the initial image and the shadow image, a shadowless image corresponding to the initial image is obtained.

This application claims the priority of Chinese Patent Application No. 202310525253.X, entitled “METHOD, DEVICE, STORAGE MEDIUM AND PROGRAM PRODUCT OF SHADOW ELIMINATION,” filed on May 10, 2023, the entire content of which is incorporated herein by reference.

### FIELD

The embodiments of the present disclosure relate to the field of computer and network communication, in particular to a method, a device, a storage medium and a program product of shadow elimination.

### BACKGROUND

When users use image acquisition devices such as mobile phones, cameras and the like to capture documents, books, photos and the like, the images captured may have shadows due to the influence of illumination. In order to obtain the effect similar to black characters on a white background scanned by a professional scanner, it is usually necessary to remove shadows from images with shadow.

A related technology is to eliminate shadows in the image by utilizing low-level features such as color and image gradient, but it can only process simple shadows and cannot process complex shadows and complex color images; another related technology is to use a neural network model, and process an image with a shadow through the neural network model to directly predict a shadowless image. That is, the input is an image with shadow, and the output is a shadowless image. But the model is complex, with an intensive computation and time consuming. Especially for high-resolution images and images with complex shadows, the time consumption is longer and the accuracy is not high.

### SUMMARY

The embodiments of the present disclosure provide a method, a device, a storage medium and a program product of shadow elimination, to improve the shadow removal effect of images, and reduce the time consumption.

In a first aspect, the embodiments of the present disclosure provide a method of shadow elimination, including: obtaining an initial image to be processed and including a shadow; obtaining, based on the initial image and a shadow prediction model, a shadow image corresponding to the initial image, where the shadow image is an image presented by a shadow in the initial image, and the shadow image excludes image content of the initial image; and obtaining, based on the initial image and the shadow image, a shadowless image corresponding to the initial image.

In a second aspect, the embodiments of the present disclosure provide a device of shadow elimination, including: an obtaining unit configured to obtain an initial image to be processed and including a shadow; a shadow extraction unit configured to obtain, based on the initial image and a shadow prediction model, a shadow image corresponding to the initial image, where the shadow image is an image presented by a shadow in the initial image, and the shadow image excludes image content of the initial image; and a shadow elimination unit configured to obtain, based on the initial image and the shadow image, a shadowless image corresponding to the initial image.

In a third aspect, the embodiments of the present disclosure provide an electronic device, including at least one processor and a memory. The memory stores computer-executable instructions. The at least one processor executes the computer-executable instructions stored by the memory to cause the at least one processor to perform the method of shadow elimination according to the above first aspect and various possible designs of the first aspect.

In a fourth aspect, the embodiments of the present disclosure provide a computer-readable storage medium. The computer-readable storage medium stores computer-executable instructions which, when executed by a processor, implement the method of shadow elimination according to the above first aspect and various possible designs of the first aspect.

In a fifth aspect, the embodiments of the present disclosure provide a computer program product, including computer-executable instructions which, when executed by a processor, implement the method of shadow elimination of the above first aspect and various possible designs of the first aspect.

### BRIEF DESCRIPTION OF DRAWINGS

In order to more clearly illustrate the embodiments of the present disclosure or the solutions in the related art, the accompanying drawings that need to be used in the description of the embodiments or the related art will be briefly introduced below. It will be apparent that the accompanying drawings in the following description are some embodiments of the present disclosure. For those skilled in the art, other drawings can be obtained according to these drawings without creative labor.

FIG. 1 is an example diagram of shadow elimination of an image;

FIG. 2 is a schematic flowchart of a method of shadow elimination provided by an embodiment of the present disclosure;

FIG. 3 is a schematic flowchart of a method of shadow elimination provided by another embodiment of the present disclosure;

FIG. 4 is a schematic diagram of a model architecture of a method of shadow elimination provided by an embodiment of the present disclosure;

FIG. 5 is a schematic flowchart of a method of shadow elimination provided by another embodiment of the present disclosure;

FIG. 6 is a schematic diagram of a preset mapping curve provided by an embodiment of the present disclosure;

FIG. 7 is a schematic flowchart of a training method of a shadow prediction model provided by another embodiment of the present disclosure;

FIG. 8a is a schematic diagram of a shadow-shaped mask provided by an embodiment of the present disclosure;

FIG. 8b is a schematic diagram of a shadow-shaped mask with a random transparency provided by an embodiment of the present disclosure;

FIG. 9 is a schematic diagram of multiple shadows provided by an embodiment of the present disclosure;

FIG. 10 is a schematic diagram of the blurring processing performed on a real shadow image provided by an embodiment of the present disclosure;

FIG. 11 is a schematic diagram of random color changes occurring at the edges of shadows provided by an embodiment of the present disclosure;

FIG. 12 is a schematic diagram of a comparison before and after adding Perlin noise to a real shadow image provided by an embodiment of the present disclosure;

FIG. 13 is a schematic flowchart of a training method for a shadow prediction model provided by another embodiment of the present disclosure;

FIG. 14 is a schematic diagram of obtaining a second loss provided by an embodiment of the present disclosure;

FIG. 15 is a structural block diagram of a device of shadow elimination provided by an embodiment of the present disclosure;

FIG. 16 is a schematic diagram of a hardware structure of an electronic device provided by an embodiment of the present disclosure.

### DETAILED DESCRIPTION

In order to make the objectives, technical solutions and advantages of the embodiments of the present disclosure clearer, the technical solutions in the embodiments of the present disclosure will be clearly and completely described below with reference to the accompanying drawings in the embodiments of the present disclosure. It is apparent that the described embodiments are a part, rather than all, of the embodiments of the present disclosure. From the embodiments of the present disclosure, all other embodiments obtained by those skilled in the art without creative labor shall fall within the scope of the present disclosure.

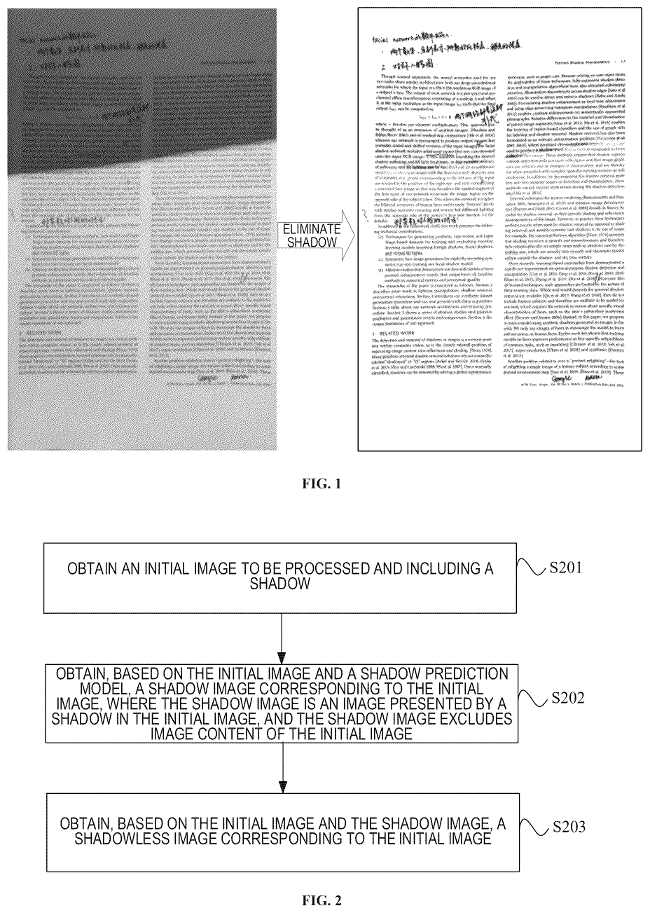

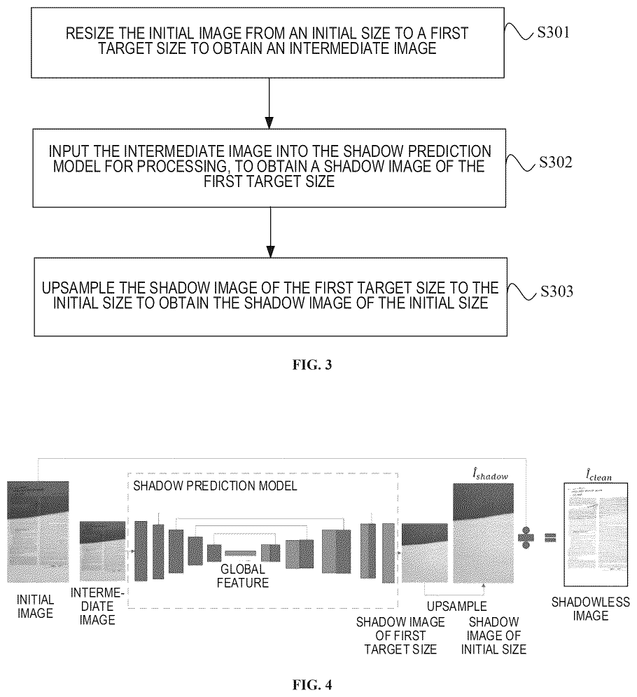

When users use image acquisition devices such as mobile phones, cameras and the like to capture documents, books, photos and the like, the images captured may have shadows due to the influence of illumination. In order to obtain the effect similar to black characters on a white background scanned by a professional scanner, it is usually necessary to remove shadows from images with shadow, as shown in FIG. 1.

A related technology is to eliminate shadows in the image by utilizing low-level features such as color and image gradient, but it can only process simple shadows and cannot process complex shadows (e.g., irregular blurring at shadow boundaries, complex shadows caused by paper creases, etc.) and complex color images; another related technology is to use a neural network model, and process an image with a shadow through the neural network model to directly predict a shadowless image. That is, the input is an image with shadow, and the output is a shadowless image. But the model is complex, with an intensive computation and time consuming. Especially for high-resolution images and images with complex shadows, the time consumption is longer and the accuracy is not high. In addition, the neural network model usually uses a rendering technology to synthesize a virtual training data set, and cannot simulate complex real illumination conditions, resulting in inaccurate models, and hard to thoroughly remove heavy shadow areas and the like.

In order to solve the above technical problems, the present disclosure provides a method of shadow elimination, which obtains an initial image to be processed and including a shadow, obtains a shadow image corresponding to the initial image based on the initial image and a shadow prediction model, where the shadow image is an image presented by a shadow in the initial image, and the shadow image excludes image content of the initial image, obtains a shadowless image corresponding to the initial image based on the initial image and the shadow image. In the embodiments of the present disclosure, the shadow image corresponding to the initial image is predicted through the shadow prediction model, and the shadow is removed from the initial image in combination with the initial image and the shadow image, without the need to directly predict the shadowless image for the initial image with the model, which reduces the complexity of the model, and also reduces the calculation amount of the model, and decreases the time consumption of calculation, and has a better shadow removal effect for the images with high resolution and complex shadow.

The method of shadow elimination according to the present disclosure is applicable in a terminal device or a server.

In a case where the method of shadow elimination according to the present disclosure is applicable to the terminal device, an initial image to be processed and including a shadow may be captured through a camera module of the terminal device; or an image including a shadow transmitted by another device may be received, or an image including a shadow stored in a local storage unit in advance may be read, as an initial image to be processed and including a shadow. Then, a specific method of shadow elimination is performed by the terminal device, to finally obtain a shadowless image.

In a case where the method of shadow elimination according to the present disclosure is applicable to the server, a camera module of the terminal device or another image acquisition device may capture to upload to the server as an initial image to be processed and including a shadow. A specific method of shadow elimination is performed by the server, to finally obtain a shadowless image. The shadowless image is then sent to the terminal device or another device.

The method of shadow elimination according to the present disclosure will be described in detail below with reference to specific embodiments.

Referring to FIG. 2, which is a schematic flowchart of a method of shadow elimination provided by an embodiment of the present disclosure. The method in this embodiment may be applied in the terminal device or the server. The method of shadow elimination includes the following steps.

S201: an initial image to be processed and including a shadow is obtained.

In this embodiment, an image acquisition device such as a mobile phone, a camera and the like may be used to capture a paper book, a document, a photo and the like, or to capture an electronic file or a picture displayed on a display of an electronic device, to obtain an image. The captured image may have a shadow due to the influence of illumination, as shown on the left side of FIG. 1, as the initial image to be processed and including a shadow in this embodiment. Alternatively, an image including a shadow transmitted by another device may be received, or an image including a shadow stored in the local storage unit in advance may be read, as an initial image to be processed and including a shadow in this embodiment.

S202: a shadow image corresponding to the initial image is obtained based on the initial image and a shadow prediction model, where the shadow image is an image presented by a shadow in the initial image, and the shadow image excludes image content of the initial image.

In this embodiment, a shadow prediction model may be pre-trained. The input of the shadow prediction model may be any image including a shadow, and the output is an image presented by a shadow included in the image. The shadow image excludes image content, and the shadow image may represent information of a shadow in the shadow image, such as a shape, a position, a color and so on. The shadow prediction model may be any machine learning model that can perform image semantic recognition or image segmentation, for example, a neural network model.

In this embodiment, after obtaining the initial image to be processed and including a shadow, the initial image may be inputted into the shadow prediction model to obtain the shadow image corresponding to the initial image. This embodiment predicts the shadow image included in the initial image through the model. This reduces the complexity of the model, decreases the calculation amount of the model, and reduces the time consumption, compared to directly predicting the shadowless image through the model. Especially, in a case of processing high-resolution images by directly predicting the shadowless image through a model, the time consumption is longer, and additionally, complex scenes (e.g., complex shadows, complex colors, such as heavy shadows) cannot be well dealt with. But predicting the shadow image through the shadow prediction model can be applied to the complex scenes and high-resolution images, and can obtain shadow images with higher accuracy, and a shorter time consumption.

S203, a shadowless image corresponding to the initial image is obtained based on the initial image and the shadow image.

In this embodiment, after the shadow image is obtained, the influence generated by the shadow image may be eliminated on the basis of the initial image, to obtain the shadowless image. In particular, the initial image may be divided by the shadow image, that is, the value of each pixel in the initial image is divided by a value of the corresponding pixel in the shadow image, to obtain the shadowless image corresponding to the initial image, so that the shadow boundary can be eliminated cleanly, while better color reproduction can be ensured.

According to the method of shadow elimination in this embodiment, an initial image to be processed and including a shadow is obtained. Based on the initial image and a shadow prediction model, a shadow image corresponding to the initial image is obtained, where the shadow image is an image presented by a shadow in the initial image, and the shadow image excludes image content of the initial image. Based on the initial image and the shadow image, a shadowless image corresponding to the initial image is obtained. In the embodiments, the shadow image corresponding to the initial image is predicted through the shadow prediction model, and the shadow is removed from the initial image in combination with the initial image and the shadow image. Since there is no need to predict the shadowless image directly for the initial image with the model, the complexity and the calculation amount of the model are reduced, and the calculation time consumption is decreased, and the shadow removal effect of the image with high resolution and complex shadow is better.

On the basis of the foregoing embodiment, S202 “based on the initial image and a shadow prediction model, a shadow image corresponding to the initial image is obtained” may specifically include:
S301, the initial image is resized from an initial size to a first target size to obtain an intermediate image;
S302, the intermediate image is inputted into the shadow prediction model for processing to obtain a shadow image of the first target size;
S303, the shadow image of the first target size is upsampled to the initial size to obtain the shadow image of the initial size.

In this embodiment, in order to further reduce the calculation amount of the model, as shown in FIG. 4, in this embodiment, the initial image is resized from the initial size (resolution) to the first target size to obtain the intermediate image. Especially for the initial image of a larger size, for example, an initial image with a size of 1125×1500, it is shrinked to 512×512, so that the shadow prediction model only needs to process the intermediate image with a relatively smaller size, thereby reducing the calculation amount of the model. For the initial image that is smaller than the first target size, it is amplified to the first target size as well, so that the shadow prediction model only needs to process images of the same size, which is convenient for deployment and training, and does not require the shadow prediction model to support a wide variety of resolutions. The resizing of the initial image does not affect the form of the shadow image, and only needs to upsample the shadow image of the first target size output by the shadow prediction model to resize to the initial size to obtain the shadow image of the same size as the initial image. In addition, this also avoids the need to prepare the training data of different resolutions during the shadow prediction model training process, to make the image quality not lost in different resolutions.

It should be noted that, since the first target size is fixed, and the aspect ratio of the initial size of the initial image may not necessarily be the same as the aspect ratio of the first target size. In the case that they are not the same, resizing the initial image from the initial size to the first target size, where the width and height of the initial image are not scaled in equal proportion, which does not affect the form of the shadow image, and finally the upsampling can still result in a shadow image of the same size as the initial image.

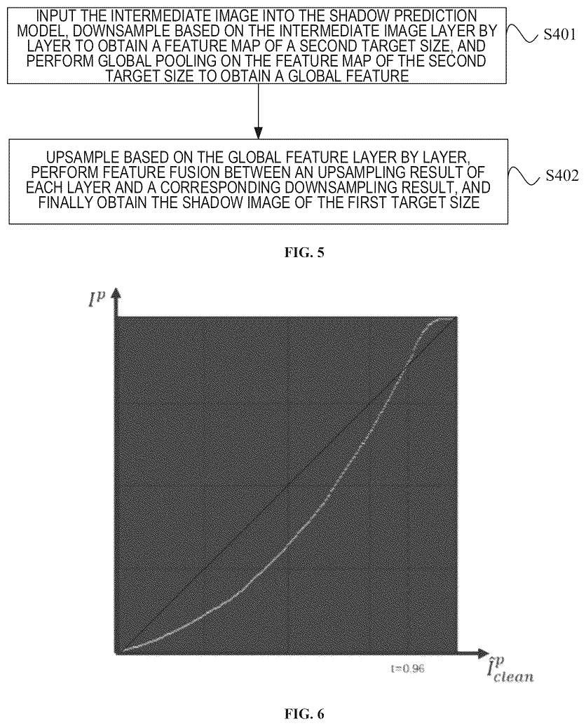

In the foregoing embodiment, referring to the shadow prediction model in FIG. 4, S302 “the intermediate image is inputted into the shadow prediction model for processing to obtain a shadow image of the first target size”, as shown in FIG. 5, may specifically include:
S401, the intermediate image is inputted into the shadow prediction model, and downsampling is performed based on the intermediate image layer by layer, to obtain a feature map of a second target size, and global pooling is performed on the feature map of the second target size to obtain a global feature;
S402, upsampling is performed based on the global feature layer by layer, and feature concat is performed between an upsampling result of each layer and a corresponding downsampling result, to finally obtain the shadow image of the first target size.

In this embodiment, the intermediate image is first downsampled layer by layer, that is, features are extracted, and the downsampling in each layer may obtain a downsampling result, that is, a feature map, and then the downsampling result is inputted to the next layer, until a feature map of the second target size is obtained. For example, the second target size is 32×32. Further, global pooling is performed on the feature map of the second target size to obtain the global feature. The global feature is 1×1, which is beneficial to learn the global illumination information of the image, so that the shadow prediction model can accurately predict the complex shadow image, thereby improving the elimination capability of the complex shadow.

After the global feature is extracted, upsampling is performed based on the global feature layer by layer. The number of layers for upsampling is the same as the number of layers for downsampling. The first layer directly performs upsampling on the global feature, and the feature concat is performed between the upsampling result and the downsampling result of the last layer. The concat result continues to be upsampled at the second layer, and the feature concat is performed between the upsampling result and the downsampling result of the penultimate layer, and so on, until the first target size is obtained by the upsampling, that is, the shadow image of the first target size is obtained. For example, the shadow prediction model as shown in FIG. 4, where the downsampling includes 5 layers, and the upsampling includes 5 layers, layer 1 for upsampling directly performs upsampling on the global feature, and the feature concat is performed between the upsampling result and the downsampling result of layer 5 for downsampling, and inputs to layer 2 for upsampling. The layer 2 for upsampling performs upsampling on the upsampling result of layer 1 for upsampling, and the feature concat is performed between the upsampling result and the downsampling result of layer 4 for downsampling, and inputs to layer 3 for upsampling, and so on. That is, layer 1 for upsampling corresponds to layer 5 for downsampling, layer 2 for upsampling corresponds to layer 4 for downsampling, layer 3 for upsampling corresponds to layer 3 for downsampling, layer 4 for upsampling corresponds to layer 2 for downsampling, layer 5 for upsampling corresponds to layer 1 for downsampling, and the feature concat is performed between the upsampling result and the downsampling result.

In the foregoing embodiment, optionally, the basic structure of the shadow prediction model may be a residual network consisting of BasicBlocks (basic blocks), or alternatively may be a Visual Geometry Group(VGG) network, or of course may be implemented with other neural networks.

On the basis of any of the foregoing embodiments, after obtaining the shadowless image corresponding to the initial image, the method further includes:

Luminance adjustment is performed on the shadowless image. The luminance is increased for a pixel in the shadowless image that has a luminance value greater than a preset threshold, and the luminance is decreased for a pixel in the shadowless image that has a luminance value less than a preset threshold.

In this embodiment, in order to make the contrast between text and background in a shadowless image more distinct, and the text clearer, the luminance adjustment may be performed on the shadowless image corresponding to the initial image obtained in the foregoing embodiments, where the pixels in the shadowless image with luminance values greater than the preset threshold are the background portion, and the luminance of the pixels of the background portion may be increased, while the pixels in the shadowless image with luminance values less than the preset threshold are the dark font portion, and the luminance of the pixels of the dark font portion may be decreased.

More specifically, in this embodiment, the luminance adjustment may be performed on each pixel of the shadowless image based on a preset mapping curve, where in the preset mapping curve, if the luminance value before adjustment is greater than the preset threshold, then a corresponding luminance value after adjustment is greater than the luminance value before adjustment, and if the luminance value before adjustment is less than the preset threshold, then a corresponding luminance value after adjustment is less than the luminance value before adjustment. The preset mapping curve is represented by a mathematical formula as follows, where the mapping curve is an S-shaped curve as shown in FIG. 6:

$${I}^{p} = \{ \begin{matrix}pow ( \frac{{\hat{I}}_{clean}^{p} - t}{1 - t} , \frac{1}{gamma} ) * ( 1 - t ) + t , if {\hat{I}}_{clean}^{p} > t \\ pow ( \frac{{\hat{I}}_{clean}^{p}}{t} , gamma ) , else\end{matrix}$$

where

$${\hat{I}}_{clean}^{p}$$

is the luminance value before adjustment (that is, the luminance value of any pixel in the shadowless image obtained in S203); and I^{p} is the luminance value after adjustment; pow represents the power function; t represents a preset threshold, which may be selected as 0.96 in this embodiment; gamma represents the curvature of the curve, the larger the value of gamma is, the larger the curvature is. That is, the portion of the curve less than t is more concave downward to achieve the effect of reducing brightness, and the portion of the curve greater than t is more convex upward to achieve the effect of increasing brightness, which may be selected to be 2.2 in this embodiment.

In the above formula, in the case that

$${\hat{I}}_{clean}^{p}$$

is in the range of t~1,

$${\hat{I}}_{clean}^{p} - t$$

and then divided by (1−t) is for normalization to the range between 0~1. Then a power function operation is performed, where the power is a value less than 1, and the curve is convex upward, then it is multiplied by (1−t), and then added t, to restore to the range of t~1. In the case that

$${\hat{I}}_{clean}^{p}$$

is in the range of 0~t, the power of the power function operation is a value greater than 1, and the curve is concave downwards.

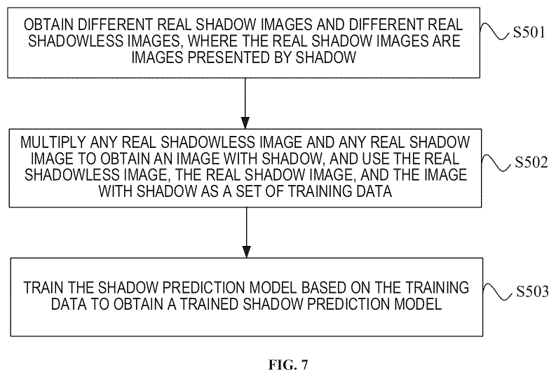

On the basis of any one of the foregoing embodiments, this embodiment further provides a training method for the shadow prediction model. As shown in FIG. 7, the training process of the shadow prediction model is as follows:
S501, different real shadow images and different real shadowless images are obtained, where a real shadow image is an image presented by a shadow;
S502, any of the real shadowless images and any of the real shadow images are multiplied to obtain images with shadow, and the real shadowless images, the real shadow images, and the images with shadow are used as a set of training data;
S503, the shadow prediction model is trained based on the training data to obtain a trained shadow prediction model.

In this embodiment, in order to train the shadow prediction model, the training data needs to be prepared. The training data includes real shadowless images, real shadow images, and images with shadow. The real shadow image is an image presented by a shadow, that is, only information such as a shape, a position and a color of the shadow is presented, while other elements are excluded. Different real shadow images and different real shadowless images may be obtained first, any of the real shadowless images and any of the real shadow images are multiplied to obtain the images with shadow. Then the real shadowless images, the real shadow images, and the images with shadow are used as a set of training data. By the above way, a plurality of sets of training data may be obtained, then the shadow prediction model is trained based on the training data to obtain the trained shadow prediction model. It should be noted that the training process may be performed on the same device with the above described application process of the shadow prediction model, or alternatively, the training process may be performed on a different device, and then the trained shadow prediction model is deployed on a device which performs the application process of the shadow prediction model.

Optionally, in obtaining the different real shadow images, the real shadow image may be captured by a camera; and/or the real shadow image may be generated by a preset algorithm, reducing the workload of capturing by generating the real shadow image.

Optionally, generating the real shadow image by a preset algorithm may include at least one of the following manners:

Manner 1: generating a shadow-shaped mask, and synthesizing the shadow-shaped mask onto a paper texture image with random transparency and random displacement to generate the real shadow image.

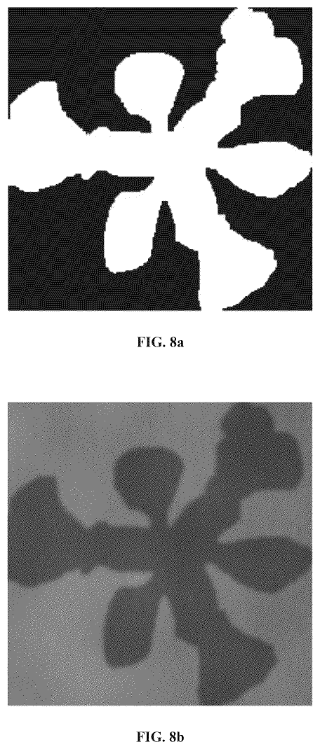

In order to make the shape of shadow richer, shape masks of various objects may be generated by an image segmentation algorithm in generating the shadow-shaped mask, as shown in FIG. 8a, as the shadow-shaped mask in this embodiment. Then, the shadow-shaped mask is synthesized onto the paper texture image with random transparency (as shown in FIG. 8b) and random displacement to obtain the real shadow image. The paper texture image may be obtained by capturing a blank paper or by any other means.

Manner 2: generating a shadow-shaped mask, and performing random offset on the shadow-shaped mask, and synthesizing the shadow-shaped masks with different offsets onto a paper texture image with random transparencies, to generate the real shadow image with multiple shadows.

Considering that there may be a plurality of light sources in a real environment, which may lead to the phenomenon of multi-layer ghosting. In order to simulate this phenomenon, in the Manner 2, random offset may be performed on the shadow-shaped mask, and the shadow-shaped masks with different offsets are superimposed with random transparencies (three multi-shadows obtained by superimposing with three different transparencies as shown in FIG. 9), and then synthesized onto the paper texture image to generate a real shadow image of the multiple shadows. The obtaining of the shadow-shaped mask and the paper texture image may refer to Manner 1.

From any of the foregoing embodiments, on the basis of the real shadow image, at least one of the following manners is further included:

Manner 3: performing blurring on each pixel of any of the real shadow images with a blur kernel.

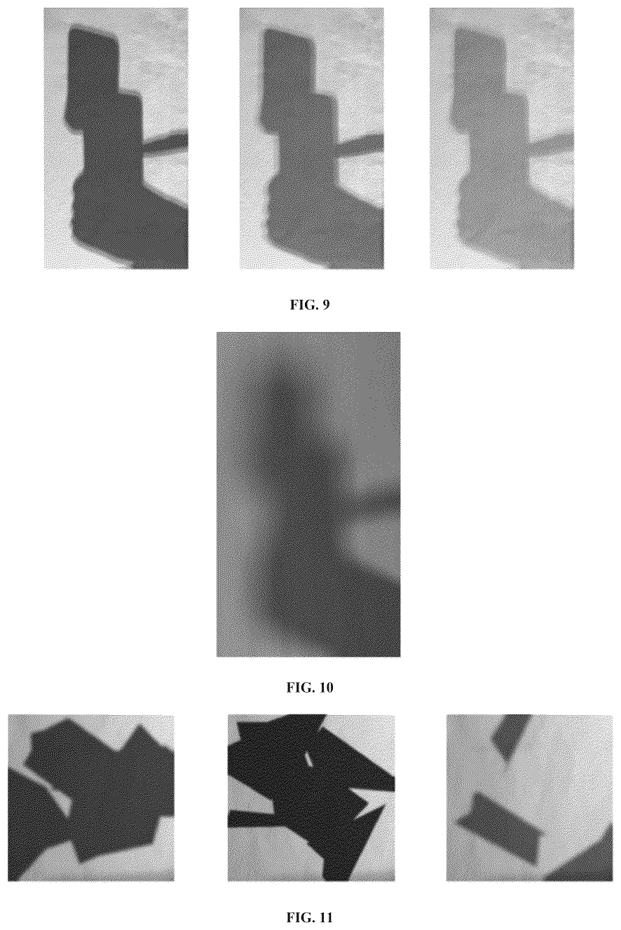

By the blurring processing, the soft shadows under the real illumination environment can be simulated, as shown in FIG. 10, which makes the synthesized real shadow image more realistic, and enriches the training data. The blur kernel may be implemented by using Gaussian kernels of different sizes, or any other blur kernels may also be used.

Manner 4: performing convolution on color channels of any of the real shadow images with a Gaussian kernel separately, so that random color change occurs at the shadow edge.

Considering that, in a real illumination environment, there are many rough micro-surfaces on the surface of the object, and the light is refracted and transmitted on these micro-surfaces. In order to simulate this phenomenon, convolution may be performed on the color channels (for example, at least one channel in the RGB channels) of the real shadow image with the Gaussian kernel, separately. The convolution may be performed with different Gaussian kernels separately, so that random color change occurs at the shadow edge, as shown in FIG. 11. In particular, due to the processing of the real shadow image, and since the inner region of the shadow is black (dark) and the outer region of the shadow is white (light), the color change is not obvious after processing, so only the color change at the shadow edge is relatively obvious.

Manner 5: generating a random Perlin noise image, and synthesizing the Perlin noise image onto the real shadow image or paper texture image.

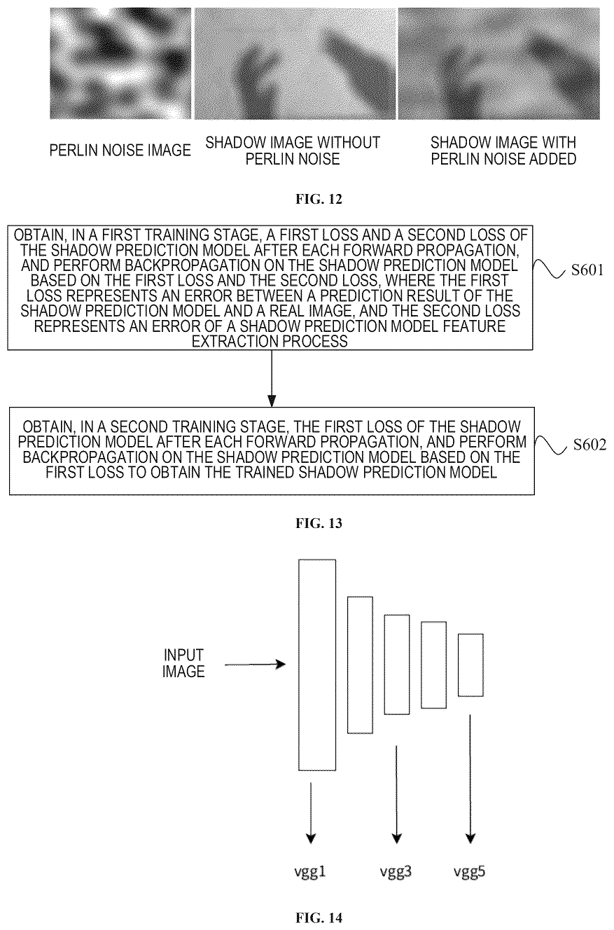

The Perlin noise is a natural noise. The random Perlin noise image may be generated through a Perlin noise generation algorithm, and the Perlin noise image is synthesized onto the real shadow image or paper texture image, to cause a light and shade change in the image space. As shown in FIG. 12, compared with a shadow image without the Perlin noise, the shadow image with the addition of the Perlin noise has the light and shade change, and is more realistic and natural.

It should be noted that Manners 3 to 5 may be further processing on the real shadow image. One of these manners may be adopted alone, or two or three manners may be adopted for mixed processing. By means of the various manners described above, a series of real shadow images that are with richer forms and more realistic can be obtained, which improves the model training effect, and enhances the robustness of the model to process different shadow situations, enabling the shadow prediction model to be applied to various complex scenes, and to be able to implement better shadow elimination on images with shadows of different forms. Especially in complex scenes such as heavy shadows, color and so on, the shadow boundaries can be eliminated cleanly, while a better color reproduction can be guaranteed.

On the basis of the embodiment described above, S503 “the shadow prediction model is trained based on the training data to obtain a trained shadow prediction model”, as shown in FIG. 13, includes:
S601, in a first training stage, a first loss and a second loss of the shadow prediction model are derived after each forward propagation, and backpropagation is performed on the shadow prediction model based on the first loss and the second loss, where the first loss represents an error between a prediction result of the shadow prediction model and the real image, and the second loss represents an error of a feature extraction process for the shadow prediction model;
S602, in a second training stage, the first loss of the shadow prediction model is derived after each forward propagation, and backpropagation is performed on the shadow prediction model based on the first loss to obtain the trained shadow prediction model.

In this embodiment, in order to make the shadow prediction model have a better shadow elimination effect for heavily shaded regions, a first loss function is designed to represent the error between the prediction result of the shadow prediction model and the real image, and a second loss function is designed to represent the error of the feature extraction process for the shadow prediction model; a training strategy of two training stages is adopted, in the first training stage, a total loss is derived based on the first loss and the second loss after each forward propagation, and backpropagation is performed on the shadow prediction model based on the total loss, to achieve the model training, which enables optimization of the shadow elimination degree of the area background in the first training stage and imposes a stronger constraint on a large-area background; through the first training stage, the shadow prediction model already has certain shadow elimination capability for the large-area background; the second loss is removed in the second training stage, and backpropagation is performed on the shadow prediction model only based on the first loss after each forward propagation, which enables finetuning of the shadow prediction model, and focusing on optimizing regions such as heavy shadows, edges, and so on, so that the shadow prediction model can accurately identify the shadow boundaries, so as to eliminate the shadow boundaries cleanly.

More specifically, in obtaining the first loss of the shadow prediction model, a first error between a predicted shadow image Î_{shadow} output by the shadow prediction model and the real shadow image I_{shadow} (which serves as the groundtruth corresponding to the predicted shadow image), and a second error between a predicted shadowless image Î_{clean} (the result of dividing an image with shadow by the predicted shadow image) and the real shadowless image I_{clean} (which serves as the groundtruth corresponding to the predicted shadowless image) may be obtained. The first loss of the shadow prediction model is then obtained based on the first error and the second error. A specific formula for calculating the first loss is as follows:

$${Loss}_{1} = \frac{\sum \{ ( 1 - {I}_{shadow} ) {L}_{1} ( {I}_{shadow} , {\hat{I}}_{shadow} ) \}}{\sum ( 1 - {I}_{shadow} )} + \frac{\sum \{ ( 1 - {I}_{shadow} ) {L}_{1} ( {I}_{clean} , {\hat{I}}_{clean} ) \}}{\sum ( 1 - {I}_{shadow} )}$$

where L₁(a,b)=|a−b|.

The first loss corresponds to that, on the basis of L1 loss (mean absolute error), the heavier the region is shaded (i.e., a region with a smaller value of real shadow image I_{shadow}), the greater the loss function is weighted, such that the shadow prediction model has a stronger shadow elimination capability for the heavily shaded region.

More specifically, in obtaining the second loss of the shadow prediction model, the predicted shadowless image and the real shadowless image may be inputted into the shadow prediction model respectively, and a downsampling result of a same target layer is obtained in a downsampling stage layer by layer, where the target layer is one or more layers in the downsampling stage; and the second loss of the shadow prediction model is determined based on an error between downsampling results of the same target layer. For example, if there are 5 layers in the downsampling stage, then layers 1, 3, and 5 may be used as the target layers. That is, when the predicted shadowless image Î_{clean} and the real shadowless image I_{clean} are inputted into the shadow prediction model respectively, the errors (for example, L1 loss) between the downsampling results of layers 1, 3, and 5 are obtained, and a sum of the errors of the respective target layers are used as the second loss of the shadow prediction model.

Taking the VGG network as an example, assuming that there are 5 layers in the downsampling stage, and layers 1, 3 and 5 are used as the target layers, as shown in FIG. 14, then the specific formula for calculating the second loss is as follows:

Loss₂=L₁(vgg₁(I_{clean}),vgg₁(Î_{clean}))+L₁(vgg₃(I_{clean}),vgg₃(Î_{clean}))+L1(vgg₅(I_{clean}),vgg₅(Î_{clean}))

where vgg₁(I_{clean}), vgg₃(I_{clean}), and vgg₅(I_{clean}) are the downsampling results (features) of layers 1, 3 and 5 respectively when the real shadowless image I_{clean} is inputted into the shadow prediction model. Similarly, vgg₁(Î_{clean}), vgg₃(Î_{clean}), and vgg₅(I_{clean}) are the downsampling results (features) of layers 1, 3 and 5 respectively when the predicted shadowless image Î_{clean} is inputted into the shadow prediction model. The second loss has a stronger constraint on the concrete semantics, and can impose a stronger constraint on the large-area background, resulting in clearer text and cleaner background after the shadow elimination.

On the basis of the embodiment described above, the first loss Loss₁ and the second loss Loss₂ are obtained in the first training stage, and the formula for calculating the total loss is as follows:

Loss=Loss₁+0.001*Loss₂

The shadow prediction model is trained based on the total loss in the first training stage, enabling optimization of the shadow elimination degree of the area background and imposing a stronger constraint on a large-area background in the first training stage.

In the second training stage, the second loss Loss₂ is removed, and the shadow prediction model is finetuned only based on the first loss Loss₁. That is, the formula for calculating the loss at this time is:

Loss=Loss₁

In the second training stage, since the shadow prediction model has a certain shadow elimination capability for the large-area background through the first training stage, the focus is to optimize regions such as heavy shadows, edges and so on in the second training stage, so that the shadow prediction model can accurately identify the shadow boundaries, so as to eliminate the shadow boundaries cleanly.

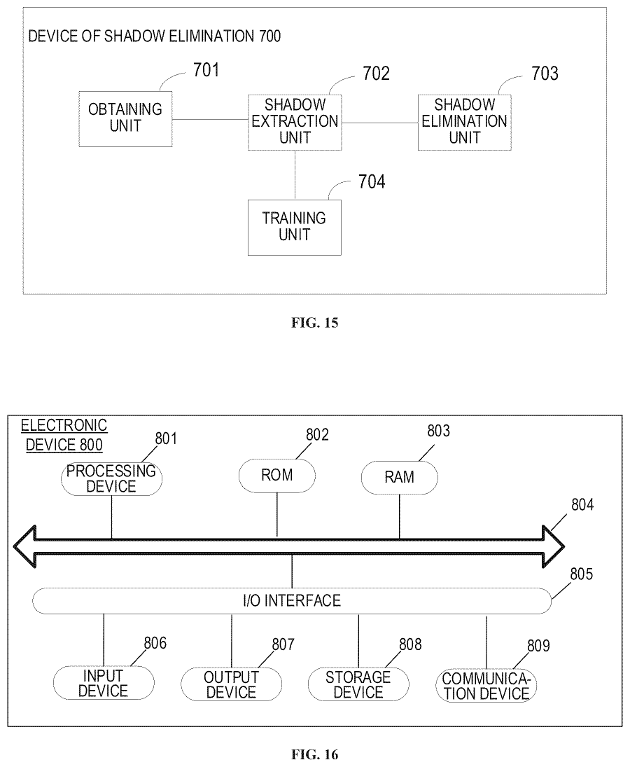

Corresponding to the method of shadow elimination in the embodiments described above, FIG. 15 is a structural block diagram of a device of shadow elimination provided by the embodiments of the present disclosure. For ease of illustration, only portions related to embodiments of the present disclosure are shown. Referring to FIG. 15, the device 700 of shadow elimination includes an obtaining unit 701, a shadow extraction unit 702, and a shadow elimination unit 703.

The obtaining unit 701 is configured to obtain an initial image to be processed and including a shadow.

The shadow extraction unit 702 is configured to obtain, based on the initial image and a shadow prediction model, a shadow image corresponding to the initial image, where the shadow image is an image presented by a shadow in the initial image, and the shadow image excludes image content of the initial image;

The shadow elimination unit 703 is configured to obtain, based on the initial image and the shadow image, a shadowless image corresponding to the initial image.

In one or more embodiments of the present disclosure, the shadow extraction unit 702, in obtaining the shadow image corresponding to the initial image based on the initial image and the shadow prediction model, is configured to:
resize the initial image from an initial size to a first target size to obtain an intermediate image;
input the intermediate image into the shadow prediction model for processing to obtain a shadow image of the first target size; and
upsample the shadow image of the first target size to the initial size to obtain the shadow image of the initial size.

In one or more embodiments of the present disclosure, the shadow extraction unit 702, in inputting the intermediate image into the shadow prediction model for processing to obtain the shadow image of the first target size, is configured to:
input the intermediate image into the shadow prediction model, downsample based on the intermediate image layer by layer to obtain a feature map of a second target size, and perform global pooling on the feature map of the second target size to obtain a global feature; and
upsample based on the global feature layer by layer, perform feature concat between an upsampling result of each layer and a corresponding downsampling result, and finally obtain the shadow image of the first target size.

In one or more embodiments of the present disclosure, the shadow elimination unit 703, in obtaining the shadowless image corresponding to the initial image based on the initial image and the shadow image, is configured to:
divide the initial image by the shadow image to obtain the shadowless image corresponding to the initial image.

In one or more embodiments of the present disclosure, the shadow elimination unit 703, after obtaining the shadowless image corresponding to the initial image, is further configured to:
perform luminance adjustment on the shadowless image, increase a luminance for a pixel in the shadowless image that has a luminance value greater than a preset threshold, and decrease a luminance for a pixel in the shadowless image that has a luminance value less than a preset threshold.

In one or more embodiments of the present disclosure, the shadow elimination unit 703, in performing luminance adjustment on the shadowless image, is configured to:
perform, based on a preset mapping curve, the luminance adjustment on each pixel of the shadowless image, where in the preset mapping curve, in accordance with a determination that a luminance value before adjustment is greater than the preset threshold, a corresponding luminance value after adjustment is greater than the luminance value before adjustment, and in accordance with a determination that the luminance value before adjustment is less than the preset threshold, the corresponding luminance value after adjustment is less than the luminance value before adjustment.

In one or more embodiments of the present disclosure, the device further includes a training unit 704 configured to:
obtain different real shadow images and different real shadowless images, where the real shadow image is an image presented by a shadow;
multiply any real shadowless image and any real shadow image to obtain an image with shadow, and use the real shadowless image, the real shadow image, and the image with shadow as a set of training data; and
train the shadow prediction model based on the training data to obtain a trained shadow prediction model.

In one or more embodiments of the present disclosure, the training unit 704, in training the shadow prediction model based on the training data to obtain the trained shadow prediction model, is configured to:
obtain, in a first training stage, a first loss and a second loss of the shadow prediction model after each forward propagation, and perform backpropagation on the shadow prediction model based on the first loss and the second loss, where the first loss represents an error between a prediction result of the shadow prediction model and a real image, and the second loss represents an error of a shadow prediction model feature extraction process; and
obtain, in a second training stage, the first loss of the shadow prediction model after each forward propagation, and perform backpropagation on the shadow prediction model based on the first loss to obtain the trained shadow prediction model.

In one or more embodiments of the present disclosure, the training unit 704, in obtaining the first loss of the shadow prediction model, is configured to:
obtain a first error between a predicted shadow image output by the shadow prediction model and a real shadow image, and predict a second error between the shadowless image and the real shadowless image; and
obtain a first loss of the shadow prediction model based on the first error and the second error.

In one or more embodiments of the present disclosure, the training unit 704, in obtaining the second loss of the shadow prediction model, is configured to:
input a predicted shadowless image and a real shadowless image into the shadow prediction model respectively, and obtain a downsampling result of a same target layer in a layer-by-layer downsampling stage, where the target layer is one or more layers in the downsampling stage; and
determine the second loss of the shadow prediction model based on an error between downsampling results of the same target layer.

In one or more embodiments of the present disclosure, the training unit 704, in obtaining the different real shadow images, performs at least one of the following:
generating a shadow-shaped mask, and synthesizing the shadow-shaped mask onto a paper texture image with random transparency and random displacement to generate the real shadow image; or
generating a shadow-shaped mask, performing random offset on the shadow-shaped mask, and synthesizing shadow-shaped masks of different offsets onto a paper texture image with random transparencies to generate the real shadow image with multiple shadows.

In one or more embodiments of the present disclosure, the training unit 704, in obtaining the different real shadow images, is further configured to:
perform blurring on each pixel of any real shadow image using a blur kernel; or
perform convolution on color channels of any real shadow image using a Gaussian kernel, so that random color change occurs at a shadow edge; or
generate a random Perlin noise image, synthesize the Perlin noise image onto any real shadow image or a paper texture image.

The device provided in this embodiment may be configured to perform the technical solutions in the foregoing method embodiments, and the implementation principles and technical effects thereof are similar, and thus will not be repeated in this embodiment.

Referring to FIG. 16, which illustrates a schematic diagram of a structure of an electronic device 800 suitable for implementing embodiments of the present disclosure. The electronic device 800 may be a terminal device or a server. The terminal device may include, but is not limited to, a mobile terminal such as a mobile phone, a notebook computer, a digital broadcast receiver, a Personal Digital Assistant (PDA), a Portable Android Device (PAD), a Portable Media Player (PMP), an in-vehicle terminal (for example, an in-vehicle navigation terminal), and a fixed terminal such as a digital TV, a desktop computer, or the like. The electronic device shown in FIG. 16 is merely an example, and should not limit the functions and scope of use of the embodiments of the present disclosure.

As shown in FIG. 16, the electronic device 800 may include a processing device 801 (for example, a central processor, a graphics processor, etc.), which may perform various appropriate actions and processing based on a program stored in a read only memory (ROM) 802 or a program loaded into a random access memory (RAM) 803 from a storage device 808. Various programs and data required by the operations of the electronic device 800 are also stored in the RAM 803. The processing device 801, the ROM 802, and the RAM 803 are connected to each other through a bus 804. Input/output (I/O) interface 805 is also connected to bus 804.

Generally, the following devices may be connected to the I/O interface 805: an input device 806 including, for example, a touch screen, a touch pad, a keyboard, a mouse, a camera, a microphone, an accelerometer, a gyroscope, etc.; an output device 807 including, for example, a Liquid Crystal Display (LCD), a speaker, a vibrator, etc.; a storage device 808 including, for example, a magnetic tape, a hard disk, etc.; and a communication device 809. The communication device 809 may allow the electronic device 800 to communicate wirelessly or wired with other devices to exchange data. While FIG. 16 shows the electronic device 800 having various devices, it should be understood that it is not required to implement or have all illustrated devices. More or fewer devices may alternatively be implemented or provided.

In particular, according to the embodiments of the present disclosure, the process described above with reference to the flowchart may be implemented as a computer software program. For example, the embodiments of the present disclosure include a computer program product including a computer program embodied on a computer readable medium, and the computer program contains a program code for performing the method shown in the flowchart. In such embodiments, the computer program may be downloaded and installed from the network through the communication device 809, or installed from the storage device 808, or installed from the ROM 802. When the computer program is executed by the processing device 801, the foregoing functions defined in the method of the embodiments of the present disclosure are performed.

It should be noted that the computer-readable medium described above may be a computer readable signal medium, a computer readable storage medium, or any combination of the foregoing two. The computer-readable storage medium may be, for example, but not limited to, an electrical, magnetic, optical, electromagnetic, infrared, or semiconductor system, apparatus, or means, or any combination thereof. More specific examples of computer-readable storage media may include, but are not limited to, an electrical connection having one or more wires, a portable computer magnetic disk, a hard disk, a random access memory (RAM), a read-only memory (ROM), an erasable programmable read-only memory (EPROM or Flash memory), an optical fiber, a portable compact disc read-only memory (CD-ROM), an optical storage means, a magnetic storage means, or any suitable combination of the foregoing. In the present disclosure, a computer-readable storage medium may be any tangible medium containing or storing a program that may be used by or in connection with an instruction execution system, apparatus, or means. In the present disclosure, a computer readable signal medium may include a data signal propagated in baseband or as part of a carrier, where the computer readable program code is carried. Such propagated data signals may take a variety of forms including, but not limited to, electromagnetic signals, optical signals, or any suitable combination of the foregoing. The computer readable signal medium may also be any computer readable medium other than a computer readable storage medium that may send, propagate, or transmit a program for use by or in connection with an instruction execution system, apparatus, or means. The program code contained in the computer-readable medium may be transmitted with any suitable medium, including, but not limited to: wires, optical cables, RF (radio frequency), and the like, or any suitable combination of the foregoing.

The computer-readable medium described above may be included in the above electronic device; or may be separately present without being assembled into the electronic device.

The computer-readable medium carries one or more programs, and when the one or more programs are executed by the electronic device, causing the electronic device to perform the method shown in the foregoing embodiments.

Computer program code for performing the operations of the present disclosure may be written in one or more programming languages, including object oriented programming languages, such as Java, Smalltalk, C++, and conventional procedural programming languages, such as the “C” language or similar programming languages. The program code may execute entirely on a user computer, partially on a user computer, as a stand-alone software package, partially on a user computer and partially on a remote computer, or entirely on a remote computer or server. In the case of a remote computer is involved, the remote computer may be connected to the user computer or may be connected to an external computer (for example, using an Internet service provider for Internet connection) through any kind of network, including a local area network (LAN) or a wide area network (WAN).

The flowcharts and block diagrams in the figures illustrate system architecture, functionality, and operation of systems, methods, and computer program products that can be implemented according to various embodiments of the present disclosure. In this regard, each block in the flowchart or block diagram may represent a module, program segment, or portion of code that contains one or more executable instructions for implementing the specified logical function. It should also be noted that in some alternative implementations, the functions noted in the blocks may also occur in a different order than that illustrated in the figures. For example, two consecutively represented blocks may actually be performed substantially in parallel, which may sometimes be performed in the reverse order, depending on the functionality involved. It is also noted that each block in the block diagrams and/or flowcharts, as well as combinations of blocks in the block diagrams and/or flowcharts, may be implemented with a dedicated hardware-based system that performs the specified functions or operations, or may be implemented with a combination of dedicated hardware and computer instructions.

The units involved in the embodiments of the present disclosure may be implemented in software, or may be implemented in hardware. Herein, the name of the unit does not constitute a limitation on the unit itself, for example, the first obtaining unit may be further described as “the unit that obtaining at least two Internet Protocol addresses”.

The functions described above may be performed, at least in part, by one or more hardware logic components. For example, without limitation, example types of hardware logic components that may be used include: field programmable gate arrays (FPGAs), application specific integrated circuits (ASICs), application specific standard products (ASSPs), system on chip (SOCs), complex programmable logic devices (CPLDs), and the like.

In the context of the present disclosure, a machine-readable medium may be a tangible medium that may contain or store a program for use by or in connection with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, apparatus, or devices, or any suitable combination of the foregoing. More specific examples of machine-readable storage media may include electrical connection having one or more wires, a portable computer disk, a hard disk, a random access memory (RAM), a read-only memory (ROM), an erasable programmable read-only memory (EPROM or Flash memory), an optical fiber, a portable compact disc read-only memory (CD-ROM), an optical storage means, a magnetic storage means, or any suitable combination of the foregoing.

It should be noted that the user information (including but not limited to various images, etc.) and data (including, but not limited to, data for analysis, stored data, displayed data, etc.) involved in the present disclosure are all information and data authorized by the user or sufficiently authorized by the parties. And collection, use and processing of the related data needs to comply with relevant laws and regulations and standards of relevant countries and areas, and provide a corresponding operation entrance for the user to select authorization or decline.

The first aspect, a shadow elimination method is provided according to one or more embodiments of the present disclosure, including: obtaining an initial image to be processed and including a shadow; obtaining, based on the initial image and a shadow prediction model, a shadow image corresponding to the initial image, where the shadow image is an image presented by a shadow in the initial image, and the shadow image excludes image content of the initial image; and obtaining, based on the initial image and the shadow image, a shadowless image corresponding to the initial image.

According to one or more embodiments of the present disclosure, obtaining, based on the initial image and the shadow prediction model, the shadow image corresponding to the initial image includes: scaling the initial image from an initial size to a first target size to obtain an intermediate image; inputting the intermediate image into the shadow prediction model for processing to obtain a shadow image of the first target size; and upsampling the shadow image of the first target size to the initial size to obtain the shadow image of the initial size.

According to one or more embodiments of the present disclosure, inputting the intermediate image into the shadow prediction model for processing to obtain the shadow image of the first target size includes: inputting the intermediate image into the shadow prediction model, downsampling based on the intermediate image layer by layer to obtain a feature map of a second target size, and performing global pooling on the feature map of the second target size to obtain a global feature; and upsampling based on the global feature layer by layer, performing feature concat between an upsampling result of each layer and a corresponding downsampling result, and finally obtaining the shadow image of the first target size.

According to one or more embodiments of the present disclosure, obtaining, based on the initial image and the shadow image, the shadowless image corresponding to the initial image includes: dividing the initial image by the shadow image to obtain the shadowless image corresponding to the initial image.

According to one or more embodiments of the present disclosure, after obtaining the shadowless image corresponding to the initial image, the method further includes: performing luminance adjustment on the shadowless image, increasing a luminance for a pixel in the shadowless image that has a luminance value greater than a preset threshold, and decreasing a luminance for a pixel in the shadowless image that has a luminance value less than a preset threshold.

According to one or more embodiments of the present disclosure, performing luminance adjustment on the shadowless image includes: performing, based on a preset mapping curve, the luminance adjustment on each pixel of the shadowless image, where in the preset mapping curve, in accordance with a determination that a luminance value before adjustment is greater than the preset threshold, a corresponding luminance value after adjustment is greater than the luminance value before adjustment, and in accordance with a determination that the luminance value before adjustment is less than the preset threshold, the corresponding luminance value after adjustment is less than the luminance value before adjustment.

According to one or more embodiments of the present disclosure, the shadow prediction model is obtained by training through the following process: obtaining different real shadow images and different real shadowless images; where the real shadow image is an image presented by a shadow; multiplying any real shadowless image and any real shadow image to obtain an image with shadow, and using the real shadowless image, the real shadow image, and the image with shadow as a set of training data; training the shadow prediction model based on the training data to obtain a trained shadow prediction model.

According to one or more embodiments of the present disclosure, training the shadow prediction model based on the training data to obtain the trained shadow prediction model includes: obtaining, in a first training stage, a first loss and a second loss of the shadow prediction model after each forward propagation, and performing backpropagation on the shadow prediction model based on the first loss and the second loss, where the first loss represents an error between a prediction result of the shadow prediction model and a real image, and the second loss represents an error of a shadow prediction model feature extraction process; obtaining, in a second training stage, the first loss of the shadow prediction model after each forward propagation, and performing backpropagation on the shadow prediction model based on the first loss to obtain the trained shadow prediction model.

According to one or more embodiments of the present disclosure, obtaining the first loss of the shadow prediction model includes: obtaining a first error between a predicted shadow image output by the shadow prediction model and a real shadow image, and predicting a second error between the shadowless image and the real shadowless image; obtaining a first loss of the shadow prediction model based on the first error and the second error.

According to one or more embodiments of the present disclosure, obtaining the second loss of the shadow prediction model includes: inputting a predicted shadowless image and a real shadowless image into the shadow prediction model respectively, and obtaining a downsampling result of a same target layer in a layer-by-layer downsampling stage, where the target layer is one or more layers in the downsampling stage; determining the second loss of the shadow prediction model based on an error between downsampling results of the same target layer.

According to one or more embodiments of the present disclosure, obtaining the different real shadow images includes at least one of the following: generating a shadow-shaped mask, and synthesizing the shadow-shaped mask onto a paper texture image with random transparency and random displacement to generate the real shadow image; or generating a shadow-shaped mask, performing random offset on the shadow-shaped mask, and synthesizing shadow-shaped masks of different offsets onto a paper texture image with random transparencies to generate the real shadow image with multiple shadows.

According to one or more embodiments of the present disclosure, obtaining the different real shadow images further includes at least one of the following: performing blurring on each pixel of any real shadow image using a blur kernel; or performing convolution on color channels of any real shadow image using a Gaussian kernel, so that random color change occurs at a shadow edge; or generating a random Perlin noise image, synthesizing the Perlin noise image onto any real shadow image or a paper texture image.

According to a second aspect, according to one or more embodiments of the present disclosure, there is provided a shadow elimination device, including: an obtaining unit configured to obtain an initial image to be processed and including a shadow; a shadow extraction unit configured to obtain, based on the initial image and a shadow prediction model, a shadow image corresponding to the initial image, where the shadow image is an image presented by a shadow in the initial image, and the shadow image excludes image content of the initial image; a shadow elimination unit configured to obtain, based on the initial image and the shadow image, a shadowless image corresponding to the initial image.

According to one or more embodiments of the present disclosure, the shadow extraction unit, in obtaining the shadow image corresponding to the initial image based on the initial image and the shadow prediction model, is configured to: resize the initial image from an initial size to a first target size to obtain an intermediate image; input the intermediate image into the shadow prediction model for processing to obtain a shadow image of the first target size; and upsample the shadow image of the first target size to the initial size to obtain the shadow image of the initial size.

According to one or more embodiments of the present disclosure, the shadow extraction unit, in inputting the intermediate image into the shadow prediction model for processing to obtain the shadow image of the first target size, is configured to: input the intermediate image into the shadow prediction model, downsample based on the intermediate image layer by layer to obtain a feature map of a second target size, and perform global pooling on the feature map of the second target size to obtain a global feature; and upsample based on the global feature layer by layer, perform feature concat between an upsampling result of each layer and a corresponding downsampling result, and finally obtain the shadow image of the first target size.

According to one or more embodiments of the present disclosure, the shadow elimination unit, in obtaining the shadowless image corresponding to the initial image based on the initial image and the shadow image, is configured to: divide the initial image by the shadow image to obtain the shadowless image corresponding to the initial image.

According to one or more embodiments of the present disclosure, after obtaining the shadowless image corresponding to the initial image, the shadow elimination unit is further configured to: perform luminance adjustment on the shadowless image, increase a luminance for a pixel in the shadowless image that has a luminance value greater than a preset threshold, and decrease a luminance for a pixel in the shadowless image that has a luminance value less than a preset threshold.

According to one or more embodiments of the present disclosure, the shadow elimination unit, in performing luminance adjustment on the shadowless image, is configured to: perform based on a preset mapping curve, the luminance adjustment on each pixel of the shadowless image, where in the preset mapping curve, in accordance with a determination that a luminance value before adjustment is greater than the preset threshold, a corresponding luminance value after adjustment is greater than the luminance value before adjustment, and in accordance with a determination that the luminance value before adjustment is less than the preset threshold, the corresponding luminance value after adjustment is less than the luminance value before adjustment.

According to one or more embodiments of the present disclosure, the device further includes a training unit, configured to: obtain different real shadow images and different real shadowless images; where the real shadow image is an image presented by a shadow; multiply any real shadowless image and any real shadow image to obtain an image with shadow, and using the real shadowless image, the real shadow image, and the image with shadow as a set of training data; train the shadow prediction model based on the training data to obtain a trained shadow prediction model.

According to one or more embodiments of the present disclosure, the training unit, in training the shadow prediction model based on the training data to obtain the trained shadow prediction model, is configured to: obtain, in a first training stage, a first loss and a second loss of the shadow prediction model after each forward propagation, and perform backpropagation on the shadow prediction model based on the first loss and the second loss, where the first loss represents an error between a prediction result of the shadow prediction model and a real image, and the second loss represents an error of a shadow prediction model feature extraction process; obtain, in a second training stage, the first loss of the shadow prediction model after each forward propagation, and perform backpropagation on the shadow prediction model based on the first loss to obtain the trained shadow prediction model.

According to one or more embodiments of the present disclosure, the training unit, in obtaining the first loss of the shadow prediction model, is configured to: obtain a first error between a predicted shadow image output by the shadow prediction model and a real shadow image, and predict a second error between the shadowless image and the real shadowless image; obtain a first loss of the shadow prediction model based on the first error and the second error.

According to one or more embodiments of the present disclosure, the training unit, in obtaining the second loss of the shadow prediction model, is configured to: input a predicted shadowless image and a real shadowless image into the shadow prediction model respectively, and obtain a downsampling result of a same target layer in a layer-by-layer downsampling stage, where the target layer is one or more layers in the downsampling stage; determine the second loss of the shadow prediction model based on an error between downsampling results of the same target layer.

According to one or more embodiments of the present disclosure, in obtaining the different real shadow images, the training unit performs at least one of the following: generating a shadow-shaped mask, and synthesizing the shadow-shaped mask onto a paper texture image with random transparency and random displacement to generate the real shadow image; or generating a shadow-shaped mask, performing random offset on the shadow-shaped mask, and synthesizing shadow-shaped masks of different offsets onto a paper texture image with random transparencies to generate the real shadow image with multiple shadows.

According to one or more embodiments of the present disclosure, in obtaining the different real shadow images, the training unit is further configured to: perform blurring on each pixel of any real shadow image using a blur kernel; or perform convolution on color channels of any real shadow image using a Gaussian kernel, so that random color change occurs at a shadow edge; or generate a random Perlin noise image, synthesize the Perlin noise image onto any real shadow image or a paper texture image.

According to a third aspect, an electronic device is provided according to one or more embodiments of the present disclosure. The electronic device includes at least one processor and a memory storing computer-executable instructions. The at least one processor executes the computer-executable instructions stored by the memory, to cause the at least one processor to perform the method of the shadow elimination of the above first aspect and various possible designs of the first aspect.

According to a fourth aspect, a computer-readable storage medium is provided according to one or more embodiments of the present disclosure. The computer-readable storage medium stores computer-executable instructions which, when executed by a processor, implement the method of shadow elimination of the above first aspect and various possible designs of the first aspect.

According to a fifth aspect, a computer program product is provided according to one or more embodiments of the present disclosure, including computer-executable instructions which, when executed by a processor, implementing the shadow elimination method of the above first aspect and various possible designs of the first aspect.

The above description is merely an illustration of the preferred embodiments of the present disclosure and the principles of the application. It should be understood by those skilled in the art that the present disclosure scope involved in the present disclosure in the present disclosure is not limited to the technical solutions of the specific combination of the above technical features, and should also cover other technical solutions formed by any combination of the above technical features or their equivalent features without departing from the above disclosed concept. For example, the technical solutions formed by above features mutually replacing technical features disclosed in the present disclosure (but not limited to) which have similar functions.

Further, while various operations are depicted in a particular order, this should not be construed as requiring these operations to be performed in the particular order shown or in sequential order. In certain circumstances, multitasking and parallel processing may be advantageous. Likewise, while several specific implementation details are included in the discussion above, these should not be construed as limiting the scope of the present disclosure. Certain features described in the context of separate embodiments may also be implemented in combination in a single embodiment. Conversely, the various features described in the context of a single embodiment may also be implemented in multiple embodiments either individually or in any suitable sub-combination.

Although the present subject matter has been described in language specific to structural features and/or methodological acts, it is to be understood that the subject matter defined in the appended claims is not necessarily limited to the specific features or acts described above. Rather, the specific features and acts described above are merely example forms of implementing the claims.

1. A method of shadow elimination, comprising:
obtaining an initial image to be processed and comprising a shadow;
obtaining, based on the initial image and a shadow prediction model, a shadow image corresponding to the initial image, wherein the shadow image is an image presented by a shadow in the initial image, and the shadow image excludes image content of the initial image; and
obtaining, based on the initial image and the shadow image, a shadowless image corresponding to the initial image.

2. The method of claim 1, wherein obtaining, based on the initial image and the shadow prediction model, the shadow image corresponding to the initial image comprises:
scaling the initial image from an initial size to a first target size to obtain an intermediate image;
inputting the intermediate image into the shadow prediction model for processing to obtain a shadow image of the first target size; and
upsampling the shadow image of the first target size to the initial size to obtain the shadow image of the initial size.

3. The method of claim 2, wherein inputting the intermediate image into the shadow prediction model for processing to obtain the shadow image of the first target size comprises:
inputting the intermediate image into the shadow prediction model, downsampling based on the intermediate image layer by layer to obtain a feature map of a second target size, and performing global pooling on the feature map of the second target size to obtain a global feature; and
upsampling based on the global feature layer by layer, performing feature concat between an upsampling result of each layer and a corresponding downsampling result, and finally obtaining the shadow image of the first target size.

4. The method of claim 1, wherein obtaining, based on the initial image and the shadow image, the shadowless image corresponding to the initial image comprises:
dividing the initial image by the shadow image to obtain the shadowless image corresponding to the initial image.

5. The method of claim 1, wherein after obtaining the shadowless image corresponding to the initial image, the method further comprises:
performing luminance adjustment on the shadowless image, increasing a luminance for a pixel in the shadowless image that has a luminance value greater than a preset threshold, and decreasing a luminance for a pixel in the shadowless image that has a luminance value less than a preset threshold.

6. The method of claim 5, wherein performing luminance adjustment on the shadowless image comprises:
performing, based on a preset mapping curve, the luminance adjustment on each pixel of the shadowless image, wherein in the preset mapping curve, in accordance with a determination that a luminance value before adjustment is greater than the preset threshold, a corresponding luminance value after adjustment is greater than the luminance value before adjustment, and in accordance with a determination that the luminance value before adjustment is less than the preset threshold, the corresponding luminance value after adjustment is less than the luminance value before adjustment.

7. The method of claim 1, wherein the shadow prediction model is obtained by training through the following process:
obtaining different real shadow images and different real shadowless images; wherein the real shadow image is an image presented by a shadow;
multiplying any real shadowless image and any real shadow image to obtain an image with shadow, and using the real shadowless image, the real shadow image, and the image with shadow as a set of training data;
training the shadow prediction model based on the training data to obtain a trained shadow prediction model.

8. The method of claim 7, wherein training the shadow prediction model based on the training data to obtain the trained shadow prediction model comprises:
obtaining, in a first training stage, a first loss and a second loss of the shadow prediction model after each forward propagation, and performing backpropagation on the shadow prediction model based on the first loss and the second loss, wherein the first loss represents an error between a prediction result of the shadow prediction model and a real image, and the second loss represents an error of a shadow prediction model feature extraction process;
obtaining, in a second training stage, the first loss of the shadow prediction model after each forward propagation, and performing backpropagation on the shadow prediction model based on the first loss to obtain the trained shadow prediction model.

9. The method of claim 7, wherein obtaining the first loss of the shadow prediction model comprises:
obtaining a first error between a predicted shadow image output by the shadow prediction model and a real shadow image, and predicting a second error between the shadowless image and the real shadowless image;
obtaining a first loss of the shadow prediction model based on the first error and the second error.

10. The method of claim 7, wherein obtaining the second loss of the shadow prediction model comprises:
inputting a predicted shadowless image and a real shadowless image into the shadow prediction model respectively, and obtaining a downsampling result of a same target layer in a layer-by-layer downsampling stage, wherein the target layer is one or more layers in the downsampling stage;
determining the second loss of the shadow prediction model based on an error between downsampling results of the same target layer.

11. The method of claim 7, wherein obtaining the different real shadow images comprises at least one of the following:
generating a shadow-shaped mask, and synthesizing the shadow-shaped mask onto a paper texture image with random transparency and random displacement to generate the real shadow image; or
generating a shadow-shaped mask, performing random offset on the shadow-shaped mask, and synthesizing shadow-shaped masks of different offsets onto a paper texture image with random transparencies to generate the real shadow image with multiple shadows.

12. The method of claim 11, wherein obtaining the different real shadow images further comprises at least one of the following:
performing blurring on each pixel of any real shadow image using a blur kernel; or
performing convolution on color channels of any real shadow image using a Gaussian kernel, so that random color change occurs at a shadow edge; or
generating a random Perlin noise image, synthesizing the Perlin noise image onto any real shadow image or a paper texture image.

13. (canceled)

14. An electronic device, comprising at least one processor and a memory;
the memory storing computer-executable instructions;
wherein the at least one processor executes the computer-executable instructions stored by the memory, so that the at least one processor performs acts comprising:
obtaining an initial image to be processed and comprising a shadow;
obtaining, based on the initial image and a shadow prediction model, a shadow image corresponding to the initial image, wherein the shadow image is an image presented by a shadow in the initial image, and the shadow image excludes image content of the initial image; and
obtaining, based on the initial image and the shadow image, a shadowless image corresponding to the initial image.

15. A non transitory computer-readable storage medium storing computer-executable instructions which, when executed by a processor, implementing acts comprising:
obtaining an initial image to be processed and comprising a shadow;
obtaining, based on the initial image and a shadow prediction model, a shadow image corresponding to the initial image, wherein the shadow image is an image presented by a shadow in the initial image, and the shadow image excludes image content of the initial image; and
obtaining, based on the initial image and the shadow image, a shadowless image corresponding to the initial image.

16. (canceled)

17. The electronic device of claim 14, wherein obtaining, based on the initial image and the shadow prediction model, the shadow image corresponding to the initial image comprises:
scaling the initial image from an initial size to a first target size to obtain an intermediate image;
inputting the intermediate image into the shadow prediction model for processing to obtain a shadow image of the first target size; and
upsampling the shadow image of the first target size to the initial size to obtain the shadow image of the initial size.

18. The electronic device of claim 17, wherein inputting the intermediate image into the shadow prediction model for processing to obtain the shadow image of the first target size comprises:
inputting the intermediate image into the shadow prediction model, downsampling based on the intermediate image layer by layer to obtain a feature map of a second target size, and performing global pooling on the feature map of the second target size to obtain a global feature; and
upsampling based on the global feature layer by layer, performing feature concat between an upsampling result of each layer and a corresponding downsampling result, and finally obtaining the shadow image of the first target size.

19. The electronic device of claim 14, wherein obtaining, based on the initial image and the shadow image, the shadowless image corresponding to the initial image comprises:
dividing the initial image by the shadow image to obtain the shadowless image corresponding to the initial image.

20. The electronic device of claim 14, wherein after obtaining the shadowless image corresponding to the initial image, the acts further comprises:
performing luminance adjustment on the shadowless image, increasing a luminance for a pixel in the shadowless image that has a luminance value greater than a preset threshold, and decreasing a luminance for a pixel in the shadowless image that has a luminance value less than a preset threshold.

21. The electronic device of claim 20, wherein performing luminance adjustment on the shadowless image comprises:
performing, based on a preset mapping curve, the luminance adjustment on each pixel of the shadowless image, wherein in the preset mapping curve, in accordance with a determination that a luminance value before adjustment is greater than the preset threshold, a corresponding luminance value after adjustment is greater than the luminance value before adjustment, and in accordance with a determination that the luminance value before adjustment is less than the preset threshold, the corresponding luminance value after adjustment is less than the luminance value before adjustment.

22. The electronic device of claim 14, wherein the shadow prediction model is obtained by training through the following process:
obtaining different real shadow images and different real shadowless images; wherein the real shadow image is an image presented by a shadow;
multiplying any real shadowless image and any real shadow image to obtain an image with shadow, and using the real shadowless image, the real shadow image, and the image with shadow as a set of training data;
training the shadow prediction model based on the training data to obtain a trained shadow prediction model.
